(19) United States
(12) Patent Application Publication
(10) Pub. No.: US 2015/0062201 A1
(43) Pub. Date: Mar. 5, 2015

(54) DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Lifeng Lin, Beijing (CN); Hongming Zhan, Beijing (CN); Yongcan Wang, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/362,116

(22) PCT Filed: Dec. 16, 2013
(86) PCT No.: PCT/CN2013/089485

§ 371 Date: May 30, 2014

(30) Foreign Application Priority Data
Aug. 27, 2013 (CN) 201310378844.5

(51) Int. Cl. G09G 3/34; G09G 3/36

(52) U.S. Cl. CPC G09G 3/3413; G09G 3/3607; G09G 2320/0242; G09G 2320/0233; G09G 2320/0626
USPC 345/691; 345/102; 345/88

(57) ABSTRACT

The present invention relates to a display device, including a display panel, a backlight module under the display panel and a driving circuit, wherein, a filter substrate of the display panel includes a plurality sets of filters each of which includes a red filter, a blue filter and a transparent filter; the backlight module includes a white backlight and a green backlight; and the driving circuit drives the white backlight to emit light and drives a red and blue pixels corresponding to the red and blue filters respectively to display at odd frames (or even frames), and drives the green backlight to emit light and drives a transparent pixel corresponding to the transparent filter to display at even frames (or odd frames). With the above technical solution, the Adobe RGB color coordinates can be met while a color of a mixed light can be adjusted and brightness can be enhanced.

### FIELD OF THE INVENTION

The present invention relates to the field of display technology, and particularly to a display device.

### BACKGROUND OF THE INVENTION

A conventional display device mainly includes a display panel, a backlight module and a control system. FIG. 2 is a schematic view illustrating a structure of a display device in the prior art. As shown in FIG. 2, the display device includes a backlight module 21, a lower polarizing layer 22 is formed on the backlight module 21, a lower substrate 23 is formed on the lower polarizing layer 22, a liquid crystal layer 24 is disposed between the lower substrate 23 and a protective layer 25, and a filter layer 26 is formed on the protective layer 25, wherein, the filter layer 26 is formed of red, green and blue filters which are arranged alternately, an upper substrate 27 is formed on the filter layer 26, and an upper polarizing layer 28 is formed on the upper substrate 27. The backlight module 21 includes a backlight consisting of a LED chip 29 and phosphor 30.

The current backlight is generally a white LED backlight, and the white LED backlight is mainly made of a blue LED plus yellow phosphor, a blue LED and yellow-red phosphors, a blue LED and red-green phosphors, blue and green LEDs plus red phosphor, or red, green, and blue LEDs, which have color rendering capabilities increasing sequentially in this order.

In this field, in ascending order, specifications of color rendering capabilities of liquid crystal displays are: NTSC below 72%, NTSC 72%, sRGB matching rate 100% (hereinafter referred to as sRGB100%), and Adobe matching rate 100% (hereinafter referred to as Adobe100%). sRGB100% and Adobe100% are requirements of high-end products, and in the specifications of sRGB100% and Adobe100%, specifications of red (R)/blue (B) are the same, while as for specification of green (G), Adobe100% is higher than sRGB100%. The color rendering capability of sRGB100% is 74.1% that of Adobe100%.

TABLE 1
specifications of color rendering
capabilities of liquid crystal displays in the field

| | Adobe specifications | | sRGB specifications | |
|---|---|---|---|---|
| coordinate | x | y | x | y |
| red | 0.640 | 0.330 | 0.640 | 0.330 |
| green | 0.210 | 0.710 | 0.300 | 0.600 |
| blue | 0.150 | 0.060 | 0.150 | 0.060 |

| | | |
|---|---|---|
| NTSC color gamut | 95.5% | 70.8% |
| Adobe matching rate | 100% | 74.1% |
| sRGB matching rate | 100% | 100% |

sRGB100% can be achieved by a blue LED plus red-green phosphors. However, the Adobe matching rate is still far from 100%. There are mainly two following methods to achieve Adobe100%.

A first method is to replace a blue LED plus red-green phosphors with blue and green LEDs plus red phosphor. However, with the same power consumption, the blue and green LEDs plus red phosphor have a lower overall light efficiency, and its luminous flux is reduced by more than half compared with that of the blue LED plus red-green phosphors. Although transmittance of a filter substrate using blue and green LEDs plus red phosphor will be increased by about 8% compared with that using a blue LED plus red-green phosphors, more than 46% loss in the overall brightness of the liquid crystal display will occur.

A second method is to replace the green filter resin. Table 2 is an example of replacing the green filter resin when sRGB100% is changed to Adobe100%, wherein x and y represent color coordinates and Y represents transmittance. From Table 2, it can be seen that transmittance of the green filter resin meeting Adobe100% standard is lower than that of the green filter resin meeting sRGB100% standard by 40%.

TABLE 2
specifications of two kinds of green filter resin

| | green filter resin for | green filter resin for |
|---|---|---|
| | sRGB 100% standard | Adobe 100% standard |
| Gx | 0.284 | 0.231 |
| Gy | 0.593 | 0.664 |
| GY | 0.560 | 0.273 |

The transmittance of the green filter resin meeting the Adobe100% standard affects color coordinates of white light mixed by RGB largely. Table 3 illustrates chromaticity characteristics of RGBW of a sRGB display panel matched with an existing LED backlight and a display panel with the green filter resin meeting the Adobe100% standard, and it can be seen from Table 3 that with the green filter resin meeting the Adobe100% standard, although color coordinates of RGB may meet Adobe100%, color coordinates of the white light Wx, Wy are deviated from the standard largely. From Table 3, it can be seen that deviation of Wx is 0.011, and deviation of Wy is 0.075. The color coordinates may be finely adjusted by adjusting the color block of the white LED. However, since the deviations are large, it is difficult to correct the color coordinates of the white light to meet the standard by adjusting the color block of the white LED.

TABLE 3
chromaticity characteristics of RGBW for two display panels

| | | Adobe 100% |
|---|---|---|
| | sRGB 100% | original RB + green filter resin meeting |
| | original RGB | Adobe 100% standard |
| Rx | 0.640 | 0.640 |
| Ry | 0.330 | 0.330 |
| RY | 0.180 | 0.180 |
| Gx | 0.300 | 0.210 |
| Gy | 0.600 | 0.710 |
| GY | 60.0% | 24.0% |
| Bx | 0.150 | 0.150 |
| By | 0.060 | 0.060 |
| BY | 6.0% | 6.0% |
| Wx | 0.314 | 0.303 |
| Wy | 0.330 | 0.255 |
| WY | 28.0% | 16.0% |

Therefore, most display devices in the prior art have defects of large brightness loss, large deviations of color coordinates of the white light from the standard or low color rendering capability.

### SUMMARY OF THE INVENTION

A technical problem to be solved by the present invention is to reduce deviations of color coordinates of the white light from the standard for a display device.

To this end, the present invention discloses a display device, including a display panel, a backlight module under the display panel and a driving circuit, wherein, a filter substrate of the display panel includes a plurality sets of filters, and each set of filters include a red filter, a blue filter and a transparent filter; the backlight module includes a white backlight and a green backlight; and the driving circuit drives the white backlight to emit light and drives a red and blue pixels corresponding to the red and blue filters respectively to display at odd frames, and drives the green backlight to emit light and drives a transparent pixel corresponding to the transparent filter to display at even frames; or the driving circuit drives the white backlight to emit light and drives a red and blue pixels corresponding to the red and blue filters respectively to display at even frames, and drives the green backlight to emit light and drives a transparent pixel corresponding to the transparent filter to display at odd frames.

Preferably, the driving circuit has a refresh frequency of 120 Hz for driving the white or green backlight to emit light and driving the red, blue or transparent pixel to display.

Preferably, the red filter is made of red resin, the blue filter is made of blue resin, and the transparent filter is made of transparent material.

Preferably, the filter substrate is covered with a protective layer.

Preferably, the protective layer is made of the same material as the transparent filter.

Preferably, the white backlight is formed by encapsulating a blue LED chip and yellow phosphor, a blue LED chip and yellow-red phosphors, a blue LED chip and red-green phosphors, blue and green LED chips and red phosphor, or red, green and blue LED chips; and the green backlight is made of a green LED chip.

Preferably, a ratio of brightness between the white backlight and the green backlight is in the range of 1/1 to 1/0.1.

On the basis of the existing display device in which the white backlight and the red, green and blue filters are combined to achieve display, the display device of the present invention incorporates a green backlight and replaces the green filter in the combination of red, green and blue filters on the existing filter substrate with a transparent filter used in conjunction with the green backlight. Thus, in the display device of the present invention, there are two combinations of light sources and filters: a white backlight and red and blue filters, and a green backlight and a transparent filter, and the driving circuit is used to perform a time-sharing control on the two combinations of light sources and filters, so that color coordinates can meet requirements of Adobe red and blue color coordinates when the driving circuit drives the white backlight to emit light and drives the red and blue pixels corresponding to the red and blue filters respectively to display; and so that color coordinates can meet requirements of Adobe green color coordinates when the driving circuit drives the green backlight to emit light and drives the transparent pixel corresponding to the transparent filter to display, therefore deviation of the color coordinates of the white light from the standard can be reduced while the specifications for Adobe100% can be met. With the display device disclosed in the present invention, under the premise that the color coordinates for Adobe RGB can be met, a color of a mixed light can be adjusted and brightness can be enhanced, as well as one manufacturing process may be saved for the filter substrate to reduce the fabrication cost.

### BRIEF DESCRIPTION OF THE DRAWINGS

Features and advantages of the present invention will be understood more clearly by referring to the drawings which are schematic and should not be understood as any limit to the present invention, in the drawings:

FIG. 1 is a schematic view illustrating a structure of a display device according to an embodiment of the present invention;

FIG. 2 is a schematic view illustrating a structure of a display device in the prior art;

FIGS. 3 and 4 are schematic views respectively illustrating corresponding structures formed by two main steps in a method for forming a filter layer according to one embodiment of the present invention; and

FIG. 5 is a schematic view illustrating a corresponding structure formed by one main step in a method for forming a filter layer according to another embodiment of the present invention.

### DETAILED DESCRIPTION OF THE EMBODIMENTS

Hereinafter, embodiments of the present invention will be described in detail in conjunction with the drawings.

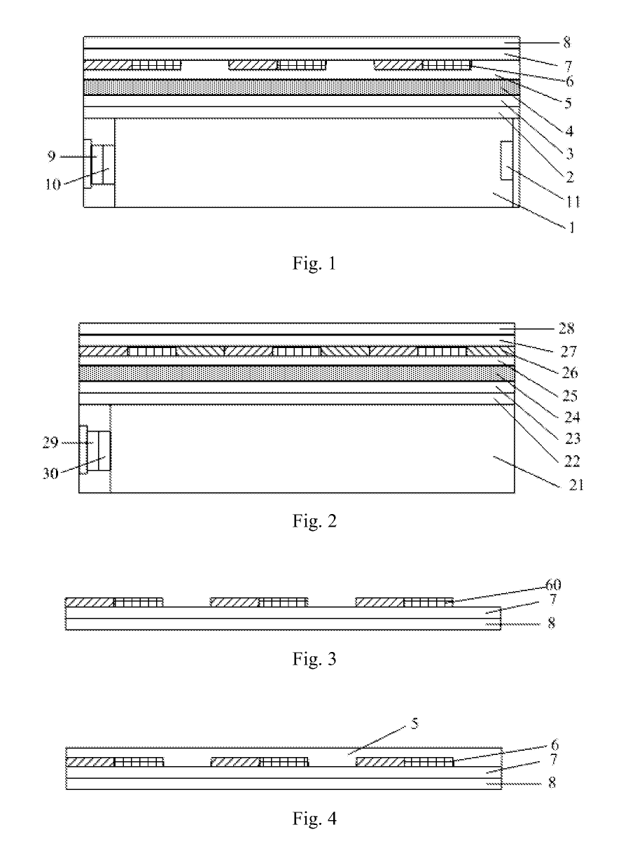

FIG. 1 is a schematic view illustrating a structure of a display device according to an embodiment of the present invention.

As shown in FIG. 1, similar to those in a display device in the prior art, a lower polarizing layer 2 is formed on a backlight module 1, a lower substrate 3 is formed on the lower polarizing layer 2, a liquid crystal layer 4 is disposed between the lower substrate 3 and a protective layer 5, a filter layer 6 is formed on the protective layer 5, an upper substrate 7 is formed on the filter layer 6 and an upper polarizing layer 8 is formed on the upper substrate 7.

The display device according to the embodiment of the present invention is different from that in the prior art in that the filter layer 6 includes a plurality of sets of filters and each set of filters consist of red, blue and transparent filters, wherein the green filter of the filter layer in the prior art is replaced with the transparent filter, and wherein the red filter is preferably made of red resin, the blue filter is preferably made of blue resin and the transparent filter is preferably made of transparent material; light sources in the backlight module 1 includes a white LED and a green LED 11, and the white LED is made by encapsulating a LED chip 9 and phosphor 10. A ratio of brightness between the white LED and the green LED may be in the range of 1/1 to 1/0.1.

The filter layer 6 according to the embodiment of the present invention may be formed by various methods. FIGS. 3 and 4 are schematic views respectively illustrating corresponding structures formed by two main steps in a method for forming the filter layer according to the embodiment of the present invention. As shown in FIG. 3, a plurality of sets of red and blue filters 60 are first formed on the upper substrate 7, and in each set of red and blue filters 60, the red filter and the blue filter are arranged adjacent to each other, there is a certain interval between two adjacent sets of red and blue filters 60, and a width of the interval is substantially the same as that of the red filter or the blue filter.

Then, as shown in FIG. 4, a protective layer 5 is formed on the plurality of sets of red and blue filters 60, and the protective layer 5 covers the plurality of sets of red and blue filters 60 and fills the intervals between every two adjacent sets of red and blue filters 60, thus the filter layer 6 is formed. The protective layer 5 is ground to have a planarization surface, or the protective layer is directly made of transparent material which can form a planarization surface, which can reduce one step required to fabricate the filter layer.

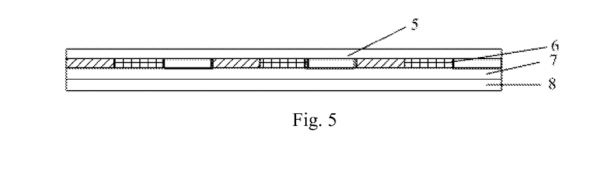

Alternatively, as shown in FIG. 5, the same method for forming red, green and blue filters in the prior art may also be used to form the red, blue and transparent filters respectively on the upper substrate 7 so as to form the filter layer 6, in which the order of forming the red, blue and transparent filters is not limited; and then the protective layer 5 is formed on the filter layer 6.

The white LED in the embodiment of the present invention may be formed by encapsulating a blue LED chip and yellow phosphor, a blue LED chip and yellow-red phosphors, a blue LED chip and red-green phosphors, a blue and green LED chips and red phosphor, or red, green and blue LED chips. A driving circuit (not shown in the drawings) may perform a time-sharing control on the white LED and the green LED 11. The driving circuit is not limited in the present invention, as long as it can drive the white LED and the green LED 11 to achieve a desired display as required. For example, the time-sharing control may be achieved by switching between two driving circuits in the prior art, one driving circuit is used to drive the white LED to emit light and its corresponding pixels to display, and the other driving circuit is used to drive the green LED 11 and its corresponding pixels to display; as another example, an integrated driving circuit may be used to drive the white LED to emit light and its corresponding pixels to display as well as drive the green LED 11 to emit light and its corresponding pixels to display in a time-sharing manner.

The display panel according to the present invention is a fast-response display panel, for example, with a refresh frequency of 120 Hz. The driving circuit drives the white LED to emit light and drives a red and blue pixels corresponding to the red and blue filters 60 to display at odd frames (or even frames), and drives the green LED to emit light and drives a transparent pixels corresponding to the transparent filters to display at even frames (or odd frames). When the driving circuit drives the white LED to emit light and drives the red and blue pixels corresponding to the red and blue filters to display, the color coordinates meet requirements of Adobe red and blue color coordinates; when the driving circuit drives the green LED to emit light and drives the transparent pixels corresponding to the transparent filters to display, the color coordinates meet requirements of Adobe green color coordinates. Therefore the specifications for Adobe100% can be met.

Further, in order to adapt various display specifications, brightness of the green LED 11 may be adjusted so that color coordinates of the mixed white light meet the various display specifications.

As one example, in the case that the LED chip 9 of the white LED is a blue LED and the phosphor 10 is red-green phosphors, color rendering capabilities of the display device according to the embodiment of the present invention, the sRGB solution and the two Adobe solutions mentioned in the BACKGROUND OF THE INVENTION are compared and the result is shown in Table 4.

TABLE 4
color rendering capability specifications of the solutions
of the present invention and the prior art

| | | Adobe comparing | | | | |
|---|---|---|---|---|---|---|
| | | solutions | | | | |
| | sRGB | | method 2 | | | |
| | solution | | with green | | | |
| | blue LED | | filter resin | | | |
| | chip plus | method 1 | meeting | | | |
| | red-green | replacing | Adobe100 | solution according to embodiment | | |
| | phosphors | backlight | % standard | of the present invention | | |
| Rx | 0.640 | 0.640 | 0.640 | 0.640 | 0.640 | 0.640 |
| Ry | 0.330 | 0.330 | 0.330 | 0.330 | 0.330 | 0.330 |
| RY | 18.0% | 22.0% | 18.0% | 22.0% | 22.0% | 22.0% |
| Gx | 0.300 | 0.210 | 0.210 | 0.210 | 0.210 | 0.210 |
| Gy | 0.600 | 0.710 | 0.710 | 0.710 | 0.710 | 0.710 |
| GY | 60.0% | 62.0% | 24.0% | 100.0% | 100.0% | 100.0% |
| Bx | 0.150 | 0.150 | 0.150 | 0.150 | 0.150 | 0.150 |
| By | 0.060 | 0.060 | 0.060 | 0.060 | 0.060 | 0.060 |
| BY | 6.0% | 6.0% | 6.0% | 6.0% | 6.0% | 6.0% |
| sRGB | 100.0% | 100.0% | 100.0% | 100.0% | 100.0% | 100.0% |
| matching | | | | | | |
| rate | | | | | | |
| Adobe | 74.1% | 100.0% | 100.0% | 100.0% | 100.0% | 100.0% |
| matching | | | | | | |
| rate | | | | | | |
| ratio of | — | — | — | 1/0.6 | 1/0.45 | 1/0.3 |
| brightness | | | | | | |
| between two | | | | | | |
| backlights | | | | | | |
| white x | 0.314 | 0.290 | 0.303 | 0.283 | 0.290 | 0.299 |
| white y | 0.330 | 0.336 | 0.255 | 0.351 | 0.317 | 0.274 |
| white Y | 28.00% | 30.30% | 16.00% | 29.33% | 24.33% | 19.33% |
| Decrease in | 0% | 46%↓ | 43%↓ | 4.7%↑ | 13.1%↓ | 31%↓ |
| brightness | (reference) | | | | | |

Wherein, the decrease in brightness is calculated in the following situation: under the same power consumption, the luminous flux of a white LED formed by encapsulating blue and green LED chips plus red phosphor is half that of a white LED made of a blue LED chip plus red-green phosphors, and the luminous flux of a green LED is the same as that of a white LED formed of a blue LED chip plus red phosphor.

It can be seen from Table 4, in the solution of the present invention, in the case that the Adobe100% is met, when a ratio of brightness between the white backlight and the green backlight is 1/0.6, the transmittance is increased by 4.7% compared with the sRGB % solution and is increased by 38% compared with the Adobe comparing solutions under the same power consumption; when a ratio of brightness between the white backlight and the green backlight is 1/0.45, the transmittance is decreased by 13.1% compared with the sRGB % solution and is increased by 30% compared with the Adobe comparing solutions under the same power consumption; when a ratio of brightness between the white backlight and the green backlight is 1/0.3, the transmittance is decreased by 31% compared with the sRGB % solution and is increased by 12% compared with the Adobe comparing solutions under the same power consumption; when a ratio of brightness between the white backlight and the green backlight is changed from 1/0.6 to 1/0.3, Wx becomes larger and Wy becomes smaller. Since specifications for white color coordinates of LCDs used in a TV, a display and a notebook are different, the white color coordinates can be adjusted by adjusting the ratio of brightness between the white backlight and the green backlight based on requirements of different products.

The method for adjusting the color deviation in the display device according to the present invention is not limited to Adobe100% specifications, and is applicable to any chromaticity requirement in which the RGB color coordinate setting is met and the white color coordinates need to be adjusted.

With the display device according to the embodiment of the present invention, under the premise that the Adobe RGB color coordinates can be met, a color of a mixed light can be adjusted and brightness can be enhanced, as well as one manufacturing process may be saved for the filter substrate to reduce the fabrication cost.

Although the embodiments of the present invention are described in conjunction with the drawings, persons skilled in the art may make various changes and modifications without departing from the spirit and the substance of the present invention and all these changes and modifications should be within the protection scope defined by the appended claims.

1. A display device, including a display panel, a backlight module under the display panel and a driving circuit, wherein,
a filter substrate of the display panel includes a plurality sets of filters, and each set of filters include a red filter, a blue filter and a transparent filter;
the backlight module includes a white backlight and a green backlight; and
the driving circuit drives the white backlight to emit light and drives a red and blue pixels corresponding to the red and blue filters respectively to display at odd frames, and drives the green backlight to emit light and drives a transparent pixel corresponding to the transparent filter to display at even frames; or the driving circuit drives the white backlight to emit light and drives a red and blue pixels corresponding to the red and blue filters respectively to display at even frames, and drives the green backlight to emit light and drives a transparent pixel corresponding to the transparent filter to display at odd frames.

2. The display device according to claim 1, wherein, the driving circuit has a refresh frequency of 120 Hz for driving the white or green backlight to emit light and driving the red, blue or transparent pixel to display.

3. The display device according to claim 1, wherein, the red filter is made of red resin, the blue filter is made of blue resin, and the transparent filter is made of transparent material.

4. The display device according to claim 1, wherein, the filter substrate is covered with a protective layer.

5. The display device according to claim 4, wherein, the protective layer is made of the same material as the transparent filter.

6. The display device according to claim 1, wherein, the white backlight is formed by encapsulating a blue LED chip and yellow phosphor, a blue LED chip and yellow-red phosphors, a blue LED chip and red-green phosphors, blue and green LED chips and red phosphor, or red, green, and blue LED chips; and the green backlight is made of a green LED chip.

7. The display device according to claim 1, wherein, a ratio of brightness between the white backlight and the green backlight is in the range of 1/1 to 1/0.1.

8. The display device according to claim 2, wherein, a ratio of brightness between the white backlight and the green backlight is in the range of 1/1 to 1/0.1.

9. The display device according to claim 3, wherein, a ratio of brightness between the white backlight and the green backlight is in the range of 1/1 to 1/0.1.

10. The display device according to claim 4, wherein, a ratio of brightness between the white backlight and the green backlight is in the range of 1/1 to 1/0.1.

11. The display device according to claim 5, wherein, a ratio of brightness between the white backlight and the green backlight is in the range of 1/1 to 1/0.1.

12. The display device according to claim 6, wherein, a ratio of brightness between the white backlight and the green backlight is in the range of 1/1 to 1/0.1.
